(19) United States
(12) Patent Application Publication
(10) Pub. No.: US 2016/0275379 A1
(43) Pub. Date: Sep. 22, 2016

(54) IMAGE PROCESSING APPARATUS AND IMAGE FORMING APPARATUS

(71) Applicant: Oki Data Corporation, Tokyo (JP)

(72) Inventor: Koji URASAWA, Tokyo (JP)

(21) Appl. No.: 14/947,819

(22) Filed: Nov. 20, 2015

(30) Foreign Application Priority Data
Mar. 20, 2015 (JP) 2015-057431

(51) Int. Cl. G06K 15/00; H04N 1/00

(52) U.S. Cl. CPC G06K 15/005; G06K 15/408; H04N 1/00477; H04N 2201/0094

(57) ABSTRACT

An image processing apparatus includes an operation unit. The operation unit sequentially displays a plurality of screens corresponding to a series of processes. And the operation unit sequentially receives input signals based on user inputs to the screens. The operation unit includes a first view area that displays contents of the series of processes. The operation unit includes a second view area that sequentially displays the screens. The contents displayed on the first view area change according to an input signal based on a user input to one of the plurality of screens.

### CROSS REFERENCE TO RELATED APPLICATIONS

This application claims priority under 35 USC 119 to Japanese Patent Application No. 2015-057431 filed on Mar. 20, 2015, the entire contents which are incorporated herein by reference.

### BACKGROUND OF THE INVENTION

1. Field of the Invention

This application relates to an image processing apparatus and an image forming apparatus.

2. Description of Related Art

When a print output result is undesirable for a user, a conventional image forming apparatus provides a desired print output result for the user by receiving input signal based on a user input through an operation panel (see, for example, Japanese Laid-open Patent Publication No. 2000-92296).

However, improvement of the operability in the operation unit is demanded, to perform user input more appropriately.

### SUMMARY OF THE INVENTION

According to an aspect of the disclosed embodiment, an image processing apparatus includes an operation unit. The operation unit sequentially displays a plurality of screens corresponding to a series of processes. And the operation unit sequentially receives input signals based on user inputs to the screens. The operation unit includes a first view area that displays contents of the series of processes. The operation unit includes a second view area that sequentially displays the plurality of screens. The contents displayed on the first view area change according to an input signal based on a user input to one of the screens.

According to another aspect of the disclosed embodiment, an image forming apparatus includes an operation unit. The operation unit sequentially displays a plurality of screens corresponding to a series of processes. And the operation unit sequentially receives input signals based on user inputs to the screens. The operation unit includes a first view area that displays contents of the series of processes. The operation unit includes a second view area that sequentially displays the plurality of screens. The contents displayed on the first view area change according to an input signal based on a user input to one of the screens.

According to this embodiment, the operability in the operation unit improves.

### BRIEF DESCRIPTION OF THE DRAWINGS

In the attached drawings:

FIG. 1 is a block diagram showing a hardware configuration of a multifunction machine;

FIG. 2 is a block diagram showing a functional configuration of a multifunction machine;

FIG. 3 is a screen transition diagram showing transition flow of a screen that is displayed on an operation unit;

FIG. 4 is a schematic view showing a home screen;

FIG. 5 is a schematic view showing a self-diagnostic start screen;

FIG. 6 is a schematic view showing a print function symptom confirmation screen;

FIG. 7 is a schematic view showing a belt-shaped line problem improvement process screen;

FIG. 8 is a schematic view showing a belt-shaped line problem confirmation screen;

FIG. 9 is a schematic view showing a belt-shaped line problem inquiry screen;

FIG. 10 is a schematic view showing a spot problem confirmation screen;

FIG. 11 is a schematic view showing a spot problem inquiry screen;

FIG. 12 is a schematic view showing a scanning function improvement process screen;

FIG. 13 is a schematic view showing a self-diagnostic end first screen;

FIG. 14 is a schematic view showing a self-diagnostic end second screen;

FIG. 15 is a schematic view showing a self-diagnostic end third screen;

FIG. 16 is a schematic view showing a self-diagnostic end fourth screen;

FIG. 17 is a schematic view showing a self-diagnostic end fifth screen;

FIG. 18 is a flowchart showing processing executed by the operation unit.

### DETAILED DESCRIPTION OF EMBODIMENTS

Hereinafter, preferred embodiments of the invention will be described with reference to the attached drawings.

### 1. Embodiment

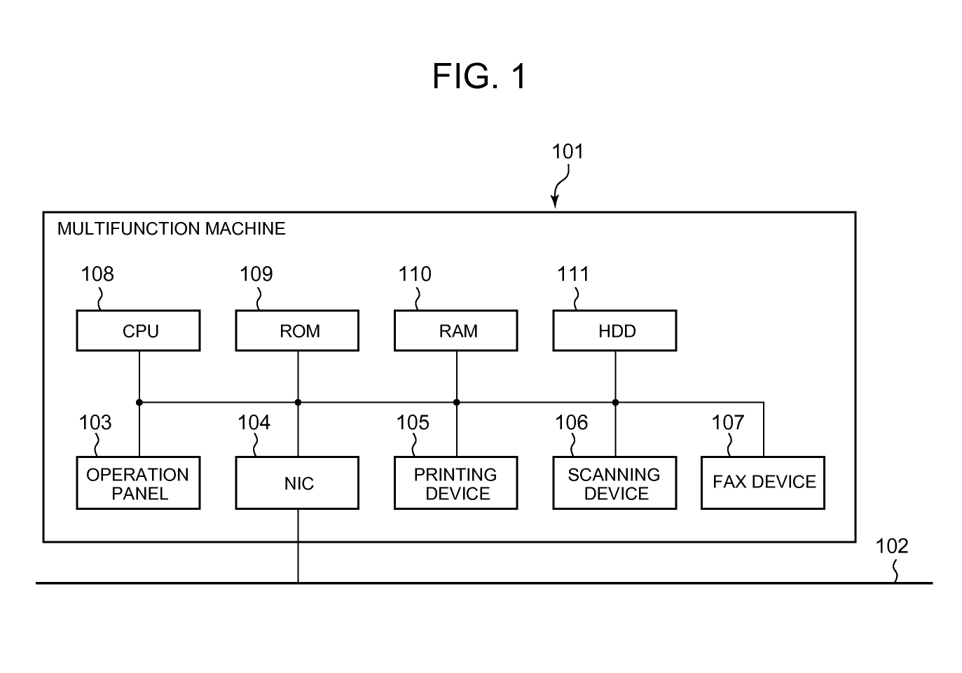

FIG. 1 is a block diagram showing a hardware configuration of multifunction machine 101.

As shown in FIG. 1, the multifunction machine 101 may include an operation panel 103, a NIC (Network Interface Card) 104, a printing device 105, a scanning device 106, a fax device 107, a CPU (Central Processing Unit) 108, a ROM (Read Only Memory) 109, a RAM (Random Access Memory) 110, and a HDD (Hard Disk Drive) 111.

The operation panel 103 may include a touch panel. The operation panel 103 displays screens. The operation panel 103 receives input signals based on a user input to the screens. NIC 104 transmits and receives data through a network 102 by using a known communication technology. A printing device 105 forms an image on a sheet such as a paper by using a known printing technology. A scanning apparatus 106 reads an image of a manuscript by using a known optical reading technology.

The fax device 107 transmits and receives image data through a telephone network by using a known communication technology. The CPU 108 controls the entire multifunction machine 101. The ROM 109 is a read only non-volatile memory. The ROM 109 stores a program and data for controlling the multifunction machine 101. The RAM 110 is a readable and writable volatile memory. The RAM 110 stores various data. The HDD 111 is a readable and writable non-volatile memory. The HDD 111 stores various data.

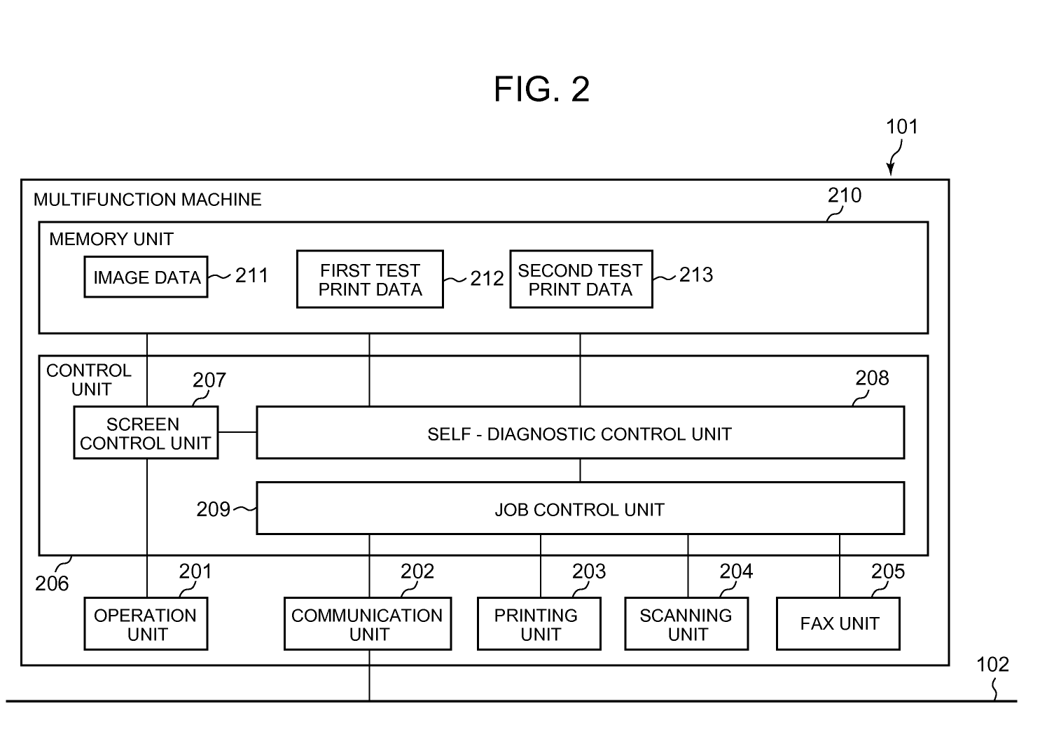

FIG. 2 is a block diagram showing a function configuration of the multifunction machine 101.

As shown in FIG. 2, the multifunction machine 101 may include an operation unit 201, a communication unit 202, a printing unit 203, a scanning unit 204, a fax unit 205, a control unit 206 and a memory unit 210.

The operation unit 201 displays screens. The operation unit 201 receives input signals based on user inputs to the screens. The communication unit 202 transmits and receives data through the network 102.

The printing unit 203 forms an image on a sheet. The scanning unit 204 reads in an image of a manuscript. The fax unit 205 transmits and receives image data through the telephone network. The control unit 206 may include a screen control unit 207, a self-diagnostic control unit 208, and a job control unit 209. The control unit 206 controls the entire multifunction machine 101.

The screen control unit 207 generates screen data by using image data 211. The screen control unit 207 outputs the screen data to the operation unit 201. The screen control unit 207 controls the operation unit 201 to display the screens by using the screen data. Then, the screen control unit 207 controls the operation unit 201 to change a displayed screen to another screen, according to the input signal received by the operation unit 201.

The self-diagnostic control unit 208 controls the job control unit 209 and the printing unit 203 to execute a printing process according to first test printing data 212 and second test printing data 213, based on an instruction from the screen control unit 207. The job control unit 209 controls the communication unit 202, the printing unit 203, the scanning unit 204, and the fax unit 205 to execute a function that the multifunction machine 101 has.

The memory unit 210 stores data used for a processing in the multifunction machine 101. Specifically, the memory unit 210 stores the image data 211, the first test printing data 212 and the second test printing data 213.

The image data 211 is used when the operation unit 201 displays a screen. The image data 211 includes layout information and icon information to draw a screen.

The first test print data 212 is used when executing a test printing process to resolve the problem of a belt-shaped line error.

The second test print data 213 is used when executing a test printing process to resolve the problem of an undesirable spot error.

Here, correspondence of the hardware configuration shown in FIG. 1 and the functional configuration shown in FIG. 2 is explained.

The operation unit 201 can be realized by the CPU 108 and the operation panel 103. The communication unit 202 can be realized by the CPU 108 and the NIC 104. The printing unit 203 can be realized by the CPU 108 and the printing device 105. The scanning unit 204 can be realized by the CPU 108 and the scanning device 106. The fax unit 205 can be realized by the CPU 108 and the fax device 107.

The memory unit 210 can be realized by the CPU 108 and the ROM 109. The memory unit 210 can be realized by the CPU 108 and the RAM 110. The memory unit 210 can be realized by the CPU 108 and the HDD 111. The control unit 206 can be realized by the CPU 108, the RAM 110 and a program stored in the ROM 109 or the HDD 111. Specifically, the control unit 206 can be realized by the CPU 108 reading out the program stored in the ROM 109 or the HDD 111 to the RAM 110.

However, it is not limited to this example. For example, all or a part of the function of the control unit 296 may be realized by an IC (Integrated Circuit) such as an ASIC (Application Specific Integrated Circuit), FPGA (Field Programmable Gate Array), and so on. Likewise, all or the part of the function of the control unit 296 may be realized by DSP (Digital Signal Processor) and so on.

Here, a self-diagnostic process executed by the control unit 210 is explained.

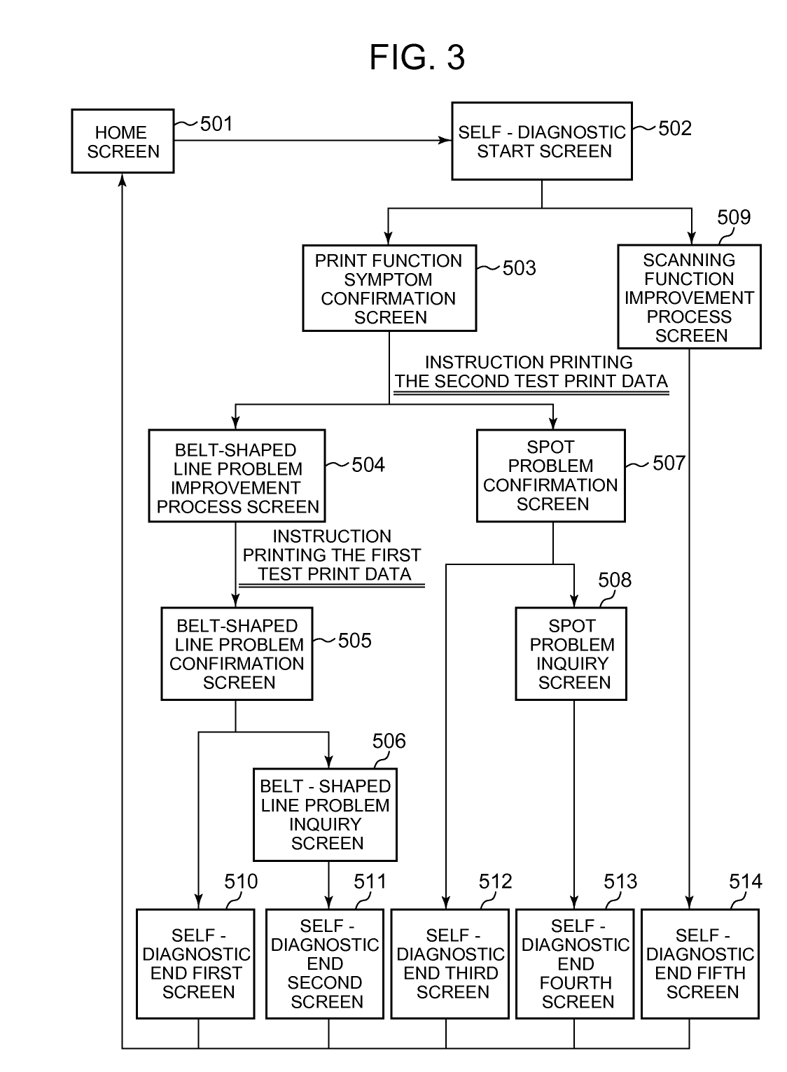

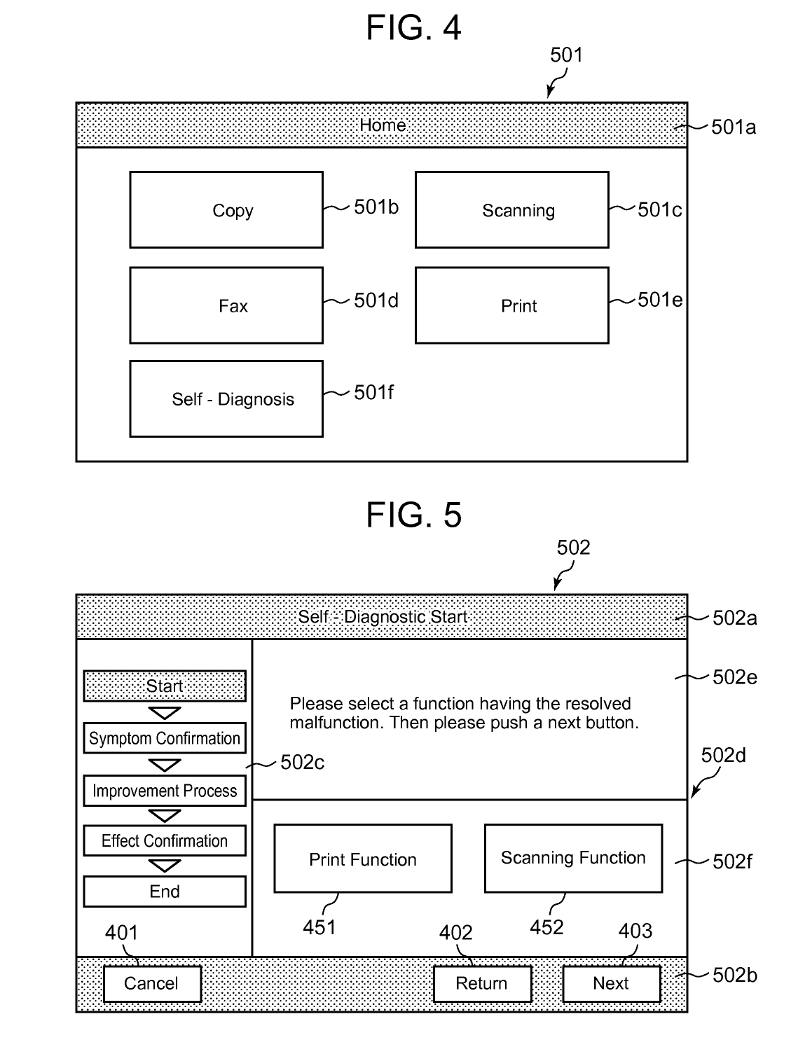

FIG. 3 is a screen transition diagram showing transitions of a screen that is displayed on the operation unit 201. The operation unit 201 changes the screen according to a user selecting operation during the self-diagnostic process executed in a wizard form. FIG. 4-FIG. 17 are schematic views showing each screen in FIG. 3. The operation unit 201 displays a home screen 501, a self-diagnostic start screen 502, a print function symptom confirmation screen 503, a belt-shaped line problem improvement process screen 504, a belt-shaped line problem confirmation screen 505, a belt-shaped line problem inquiry screen 506, a spot problem confirmation screen 507, a spot problem inquiry screen 508, a scanning function improvement process screen 509, a self-diagnostic end first screen 510, a self-diagnostic end second screen 511, a self-diagnostic end third screen 512, a self-diagnostic end fourth screen 513, and a self-diagnostic end fifth screen 514.

The operation unit 201 displays the home screen 501 as an initial menu screen. FIG. 4 is a schematic view showing the home screen 501. As shown in FIG. 4, the home screen 501 may include a title view area 501a, a copy selection button 501b, a scanning selection button 501c, a fax selection button 501d, a print selection button 501e, and a self-diagnosis button 501f. A user performs a user selecting operation using one of these buttons. Then, the multifunction machine 101 shifts to a mode corresponding to the selected button.

In this embodiment, the self-diagnosis button 501f is pushed by the user. Therefore the multifunction machine 101 shifts to a self-diagnostic mode that corresponds to the self-diagnosis button 501f. Then the operation unit 201 displays the self-diagnostic start screen 502. Namely, a screen that the operation unit 201 displays transitions from the home screen 501 to the self-diagnostic start screen 502 as shown in FIG. 3.

FIG. 5 is a schematic view showing a self-diagnostic start screen 502. As shown in FIG. 5, the self-diagnostic start screen 502 may include a title view area 502a, a forward and backward button view area 502b, a progress view area (a first view area) 502c and a message view area (a second view area) 502d. The message view area 502d may include an instruction view area 502e and a button view area 502f.

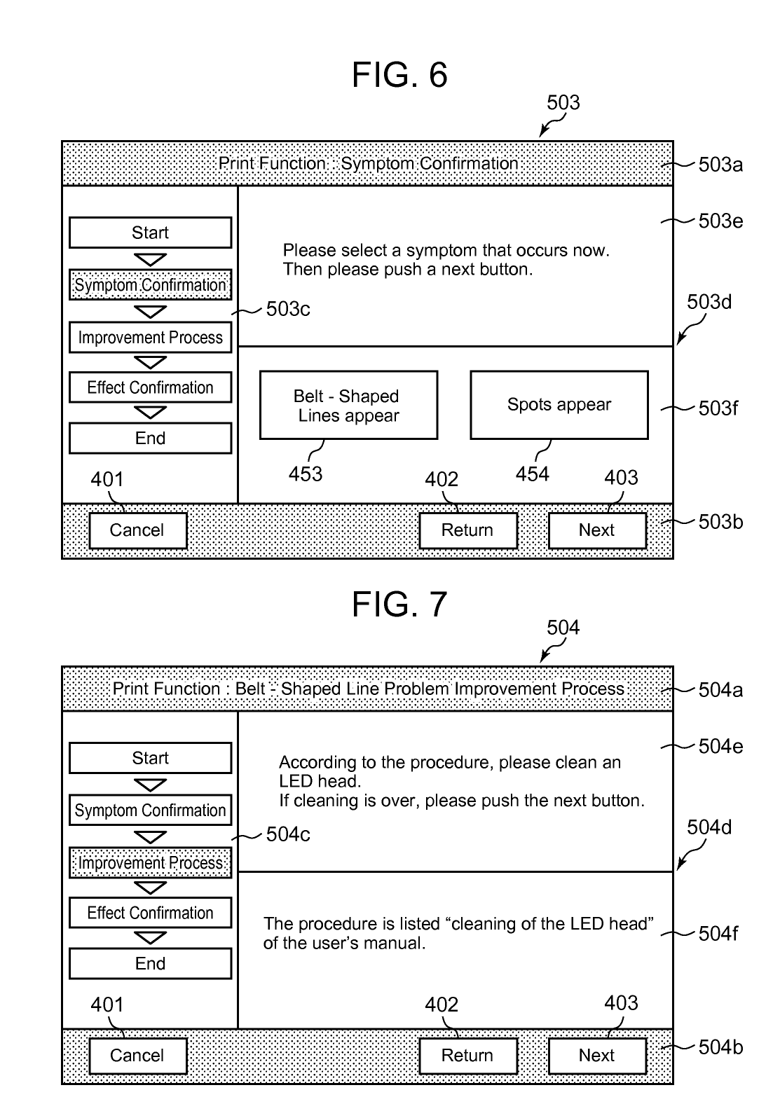

The title view area 502a is belt-shaped and is arranged in the upper part of the self-diagnostic start screen 502, in the same way as the other title view areas 503a-514a in the other screens 503-514 (FIG. 6-FIG. 17). Each of the title view areas 502a-514a displays a title of the screen that is being displayed.

The forward and backward button view area 502b is belt-shaped and is arranged in the lower part of the self-diagnostic start screen 502, in the same way as the other forward and backward button view area 503b-514b in the other screens 503-514 (FIG. 6-FIG. 17). A next button 403, a return button 402, a cancel button 401 are arranged in turn from right side toward the left side, in each of the forward and backward button view areas 502b-514b.

The progress view area 502c is arranged in the left side and the middle part of the self-diagnostic start screen 502, in the same way as the other progress view areas 503c-514c in the other screens 503-514 (FIG. 6-FIG. 17). Each of the progress view area 502c-514c displays contents of a series of processes in the self-diagnosis. Specifically, each of the progress view area 502c-514c displays processes from “Start” to “End”. Each of the process view area 502c-514c indicates the current process. Each of the contents of a series of processes is different depending on the screen transition sequence. The progress view area 502c displays “Start”, “Symptom Confirmation”, “Improvement Process”, “Effect Confirmation”, and “End”, as an initial contents of the series of processes. The progress view area 502a highlights “Start” to indicate that the current process is “Start”.

The message view area 502d is arranged on the right side and the middle part of the self-diagnostic start screen 502, in the same way as the other message view areas 503d-514d in the other screens 503-514 (FIG. 6-FIG. 17). The instruction view area 502e is arranged in the upper part of the message view area 502d, in the same way as the other instruction view areas 503e-514e in the other screens 503-514 (FIG. 6-FIG. 17). The instruction view areas 502e-514e display a message for guiding the user through the operation selection buttons. The instruction view areas 502e-514e display a message for explaining the contents of the work.

On the other hand, the button view area 502f is arranged in the lower part of the message view area 502d. Each area corresponding to the button view area 502f in the print function symptom confirmation screen 503, the belt-shaped line problem confirmation screen 505, and the spot problem confirmation screen 507 is a button view area 503f, 505f, 507f. Each area corresponding to the button view area 502f in the belt-shaped line problem improvement process screen 504, the belt-shaped line problem inquiry screen 506, the spot problem inquiry screen 508, and the scanning function improvement process screen 509 is a supplemental information view area 504f, 506f, 508f, 509f. The message view area 502f may include a print function selection button 451 and a scanning function selection button 452.

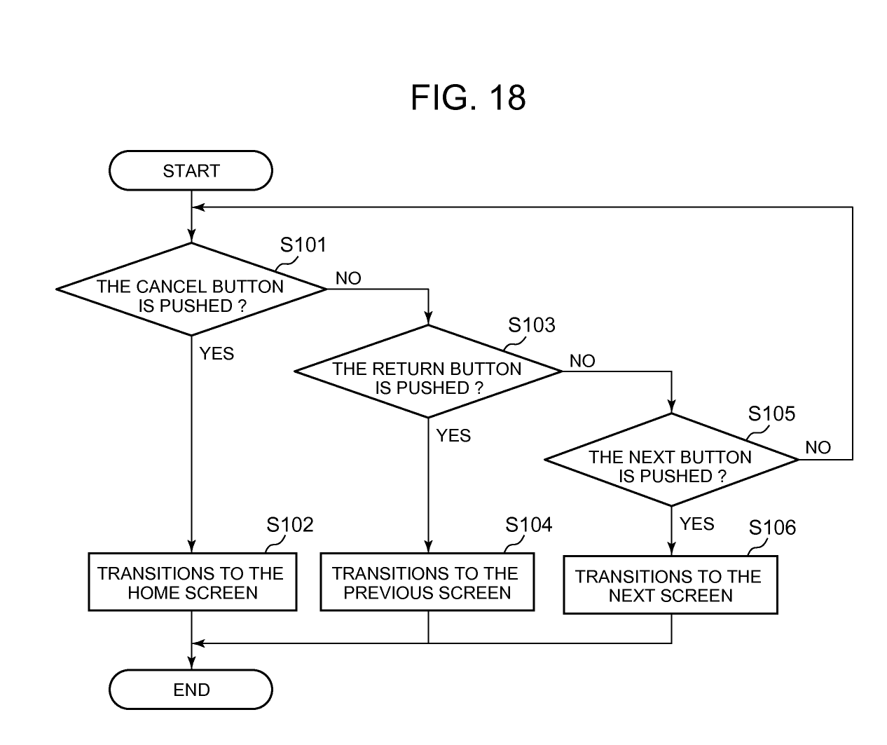

FIG. 18 is a flowchart showing the processing executed by the operation unit 201 when the forward and backward button view areas 502b-514b receive an input signal based on a user input. Here, the forward and backward button view area 502b is explained.

In the self-diagnostic start screen 502 shown in FIG. 5, if the cancel button 401 is pushed (step S101: YES), the operation unit 201 displays the home screen 501. Namely, The screen displayed on the operation unit 201 transitions from the self-diagnostic start screen 502 to the home screen 501 (step S102).

In the self-diagnostic start screen 502 shown in FIG. 5, if the return button 402 is pushed (step S103: YES), the operation unit 201 displays a previous screen (e.g. the home screen 501). Namely, the screen displayed on the operation unit 201 transitions from the self-diagnostic start screen 502 to the previous screen (step S104).

If the next button 403 is pushed (step S105: YES), the operation unit 201 displays a next screen (e.g. the print function symptom confirmation screen 503 or the scanning function improvement process screen 509). Namely, the screen displayed on the operation unit 201 transitions from the self-diagnostic start screen 502 to the next screen (step S106).

A next screen when selecting the print function selection button 451 is different from a next screen when selecting the scanning function selection button 452. Specifically, when the print function selection button 451 is pushed and then the next button 403 is pushed, the screen displayed on the operation unit 201 transitions from the self-diagnostic start screen 502 to the print function symptom confirmation screen 503. On the other hand, when the scanning function selection button 452 is pushed and then the next button 403 is pushed, the screen displayed on the operation unit 201 transitions from the self-diagnostic start screen 502 to the scanning function improvement process screen 509.

If both the print function selection button 451 and the scanning function selection button 452 are not selected, the next button 403 cannot be pushed. If one of the print function selection button 451 and the scanning function selection button 452 is selected, the color of the next button 403 is changed, namely, the next button 403 is highlighted and the next button 403 can be pushed.

Here, a screen transition from the self-diagnostic start screen 502 to the self-diagnostic end first screen 510 is explained by referring to FIG. 3, FIG. 5-FIG. 8, FIG. 13, as a first specific example of the self-diagnostic process executed by the control unit 206.

In the self-diagnostic start screen 502 shown in FIG. 5, the title view area 502a displays “Self-Diagnostic Start” as a title of a screen that is being displayed, namely, the self-diagnostic start screen 502. The title indicates that a self-diagnosis is started. The progress view area 502c displays contents of a series of processes. Specifically, the progress view area 502c displays “Start”, “Symptom Confirmation”, “Improvement Process”, “Effect Confirmation”, and “End”. The progress view area 502a highlights “Start” to indicate that the current process is “Start”.

The instruction view area 502e displays a message that promotes a selection of a function having the resolved malfunction. If the print function selection button 451 is pushed and then the next button 403 is pushed, the screen displayed on the operation unit 201 transitions from the self-diagnostic start screen 502 to the print function symptom confirmation screen 503.

In the print function symptom confirmation screen 503 shown in FIG. 6, the title view area 503a displays “Print Function: Symptom Confirmation” as a title of a screen that is being displayed, namely, the print function symptom confirmation screen 503. The title indicates that a function targeted for the self-diagnosis is a print function and a current process is a symptom confirmation. The process view area 503c highlights “Symptom Confirmation” to indicate that the current process is “symptom confirmation”.

The instruction view area 503e displays a message that promotes a selection of a symptom that has occurred. If a belt-shaped lines appearing button 453 is pushed and then the next button 403 is pushed, the screen displayed on the operation unit 201 transitions from the print function symptom confirmation screen 503 to the belt-shaped line problem improvement process screen 504.

In the belt-shaped line problem improvement process screen 504 shown in FIG. 7, the title view area 504a displays “Print Function: Belt-Shaped Line Problem Improvement Process” as a title of a screen that is being displayed, namely, the belt-shaped line problem improvement process screen 504. The title indicates that the function targeted for the self-diagnosis is a print function and a current process is a belt-shaped line problem improvement process. The process view area 504c highlights “Improvement Process” to indicate that the current process is “improvement process”.

The instruction view area 504e displays a message that suggests cleaning a LED head. The supplemental information view area 504f displays a supplemental message that the targeted operation (procedure for the cleaning) is listed in the user's manual. After the user performs the cleaning of the LED head, the next button 403 is pushed. Or without the user performing cleaning the LED head, the next button 403 is pushed. Then the screen displayed on the operation unit 201 transitions from the belt-shaped line problem improvement process screen 504 to the belt-shaped line problem confirmation screen 505.

If the screen transitions to the belt-shaped line problem confirmation screen 505, the screen control unit 207 outputs a signal of instruction for executing print processing based on the first test print data 212, to the self-diagnostic control unit 208. The self-diagnostic control unit 208 controls the printing unit 203 to form an image based on the first test printing data 212, on the sheet.

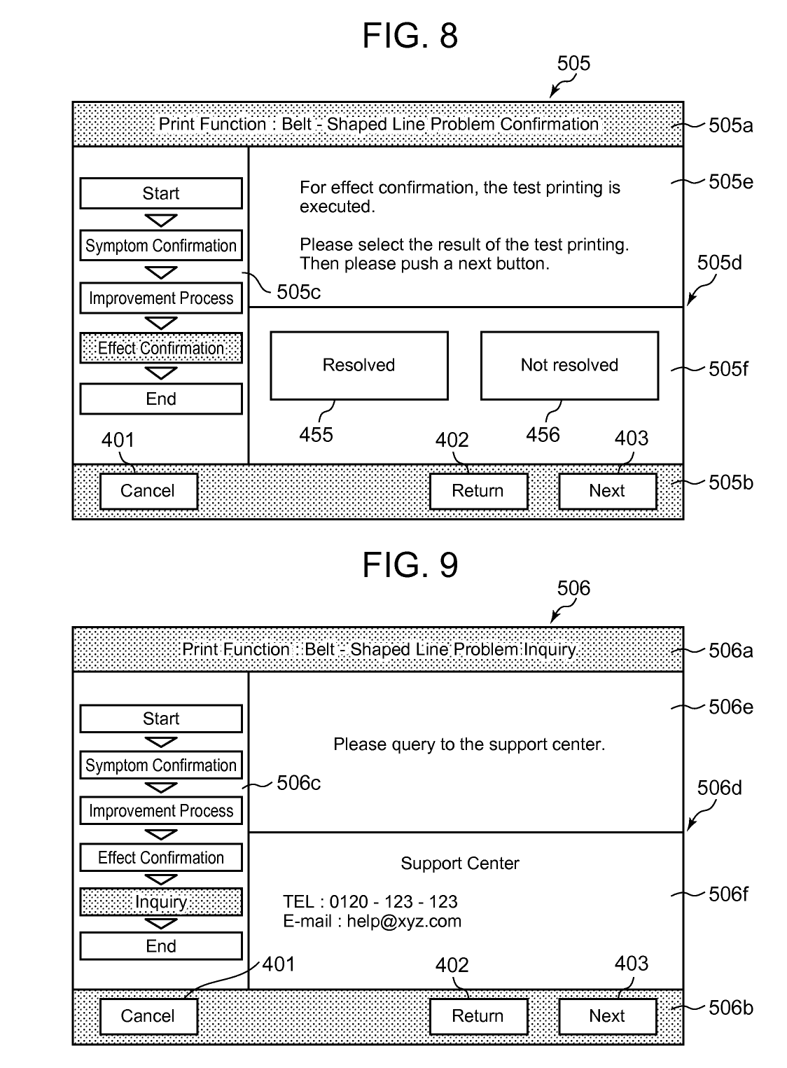

In the belt-shaped line problem confirmation screen 505 shown in FIG. 8, the title view area 505a displays “Print Function: Belt-Shaped Line Problem Confirmation” as a title of a screen that is being displayed, namely, the belt-shaped line problem confirmation screen 505. The title indicates that a function targeted for the self-diagnosis is a print function and a current process is a belt-shaped line problem confirmation. The process view area 505c highlights “Effect Confirmation” to indicate that the current process is “effect confirmation”.

The instruction view area 505e displays a message that provides the user selection as to whether or not the problem is resolved. If a resolution button 455 is pushed and then the next button 403 is pushed, the screen displayed the operation unit 201 transitions from the belt-shaped line problem confirmation screen 505 to the self-diagnostic end first screen 510.

In the self-diagnostic end first screen 510 shown in FIG. 13, the title view area 510a displays “Self-Diagnostic End” as a title of a screen that is being displayed, namely, the self-diagnostic end first screen 510. The title indicates that the self-diagnosis is ended. The process view area 510c highlights “End” to indicate that the current process is “end”.

The instruction view area 510e displays a message for guiding the user selection operation to the next button 403. If the next button 403 is pushed, the self-diagnostic process is finished and the operation unit 201 displays the home screen 501.

As described in the first specific example of the self-diagnostic process, the title view areas 502a-505a, and 510a on the screen displayed on the operation unit 201 display the targeted function name (a print function) and/or the targeted operation. The progress view areas 502c-505c and 510c on the screen displayed on the operation unit 201 display the initial contents of the series of processes. And the progress view areas 502c-505c and 510c highlight the current process. The message view areas 502d-505d and 510d in the screen displayed on the operation unit 201 display the message for guiding the user selection operation of buttons and the message for explaining the contents of the work. The message view areas 502d, 503d, 505d displays various selection buttons.

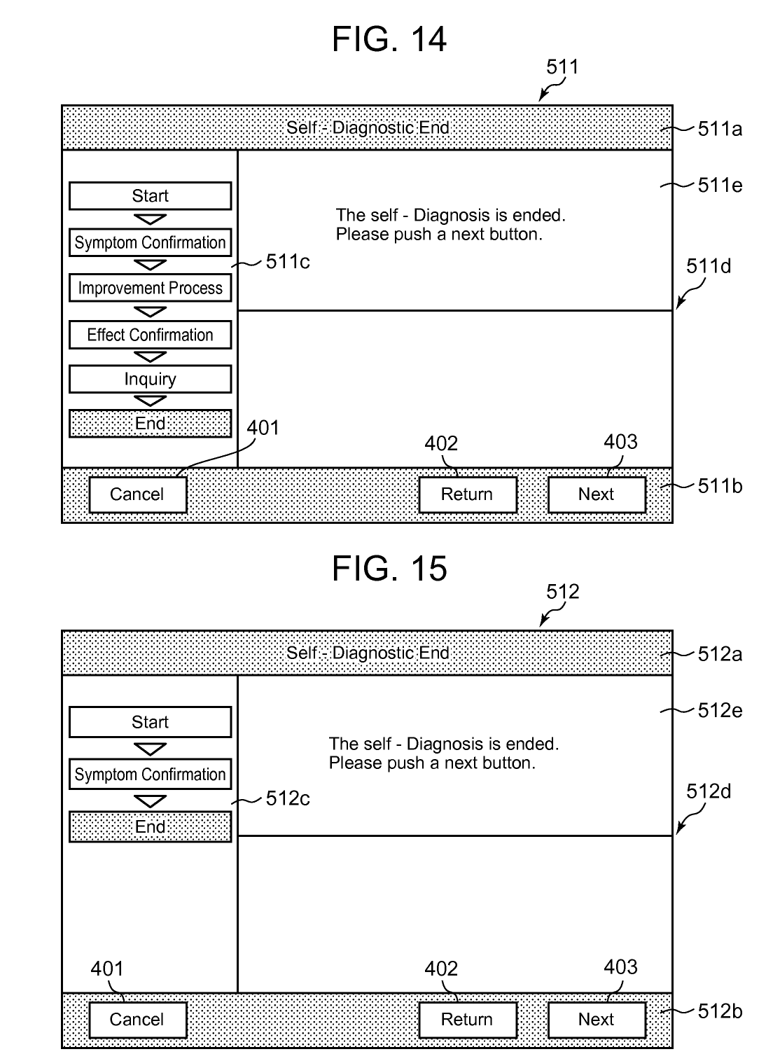

Next, a screen transition from the self-diagnostic start screen 502 to the self-diagnostic end second screen 511 is explained by referring to FIG. 3, FIG. 5-FIG. 9, FIG. 14, as a second specific example of the self-diagnostic process executed by the control unit 206. The screen transition from self-diagnostic start screen 502 to the belt-shaped line problem confirmation screen 505 is dome in the same way as the first specific example. Therefore, this explanation is omitted.

In the belt-shaped line problem confirmation screen 505 shown in FIG. 8, if a no resolution button 456 is pushed and then the next button 403 is pushed, the screen displayed on the operation unit 201 transitions from the belt-shaped line problem confirmation screen 505 to the belt-shaped line problem inquiry screen 506.

In the belt-shaped line problem inquiry screen 506 shown in FIG. 9, the title view area 506a displays “Print Function: Belt-Shaped Line Problem Inquiry” as a title of a screen that is being displayed, namely, the belt-shaped line problem inquiry screen 506. The title indicates that a function targeted for the self-diagnosis is the print function and the current process is a belt-shaped line problem inquiry.

The operation unit 201 adds the name of process “Inquiry” between “Effect Confirmation” and “End” in the progress view area 506c. The operation unit 201 highlights “Inquiry” to indicate that the current process is “Inquiry”. Namely, the operation unit 201 changes the contents of the series of processes according to the input signal based on the user selection input to the no resolution button 456 in the button view area 505f.

The instruction view area 506e displays a message that suggests an inquiry to the support center. The supplemental information view area 506f displays a supplemental message that includes a phone number and e-mail address of the support center. If the next button 403 is pushed, the operation unit 201 displays the self-diagnostic end second screen 511 shown in FIG. 14.

In the self-diagnostic end second screen 511 shown in FIG. 14, the title view 511a displays “Self-Diagnostic End” as a title of a screen that is being displayed, namely, the self-diagnostic end second screen 511. The title indicates that the self-diagnosis is ended. The process view area 511c highlights “End” to indicate that the current process is “end”.

The instruction view area 511e displays a message for guiding the user selection operation to the next button 403. If the next button 403 is pushed, the self-diagnostic process is finished and the operation unit 201 displays the home screen 501.

As described with the second specific example of the self-diagnostic process, the operation unit 201 adds the name of process “Inquiry” between “Effect Confirmation” and “End” in the progress view area 506c according to the input signal based on the user selecting operation to the no resolution button 456 in the button view area 505f.

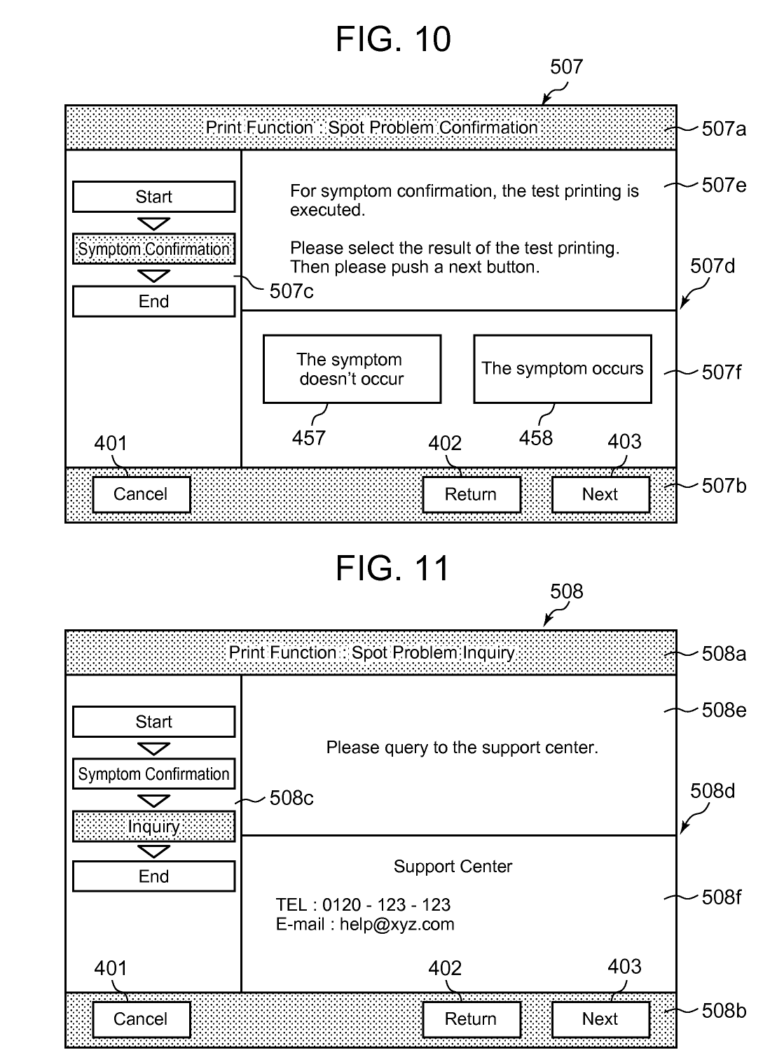

Next, a screen transition from the self-diagnostic start screen 502 to the self-diagnostic end third screen 512 is explained by referring to FIG. 3, FIG. 5, FIG. 6, FIG. 10, FIG. 15, as a third specific example of the self-diagnostic process executed by the control unit 206. The screen transition of the self-diagnostic start screen 502 and the print function symptom confirmation screen 503 is done in the same way as the first specific example. Therefore, this explanation is omitted.

In the print function symptom confirmation screen 503 shown in FIG. 6, a spots appearing button 454 is pushed and then the next button 403 is pushed, the screen displayed on the operation unit 201 transitions from the print function symptom confirmation screen 503 to the spot problem confirmation screen 507.

When the screen transitions to the spot problem confirmation screen 507, the screen control unit 207 outputs a signal of instruction for executing print processing based on the second test print data 213, to the self-diagnostic control unit 208. The self-diagnostic control unit 208 controls the printing unit 203 to form an image based on the second test print data 213, on the sheet.

In the spot problem confirmation screen 507 shown in FIG. 10, the title view area 507a displays “Print Function: Spot Problem Confirmation” as a title of a screen that is being displayed, namely, the spot problem confirmation screen 507. The title indicates that a function targeted for the self-diagnosis is a print function and a current process is a spot problem confirmation. The process view area 507c highlights “Symptom Confirmation” to indicate that the current process is the spot problem confirmation.

The processes for resolving the spot problem do not include “improvement process” and “effect confirmation”. Therefore the operation unit 201 does not display “Improvement Process” and “Effect Confirmation” in the process view area 507c. Namely, the operation unit 201 changes the contents of the series of processes according to the input signal based on the user selection of the spots appearing button 454 in the button view area 503f.

The instruction view area 507e displays a message that suggests a selection of whether or not the problem occurs. If a no occurrence button 457 is pushed and then the next button 403 is pushed, the screen displayed the operation unit 201 transitions from the spot problem confirmation screen 507 to the self-diagnostic end third screen 512.

In the self-diagnostic end third screen 512 shown in FIG. 15, the title view 512a displays “Self-Diagnostic End” as a title of a screen that is being displayed, namely, the self-diagnostic end third screen 512. The title indicates that the self-diagnosis is ended. The process view area 512c highlights “End” to indicate that the current process is “end”.

The instruction view area 512e displays a message for guiding the user selection operation to the next button 403. If the next button 403 is pushed, the self-diagnostic process is finished and the operation unit 201 displays the home screen 501.

As described with the third specific example of the self-diagnostic process, the operation unit 201 deletes the name (the content) of process “Improvement Process” and “Effect Confirmation” in the progress view area 507c according to the input signal based on the user selection operation to the spots appearing button 454 in the button view area 503f.

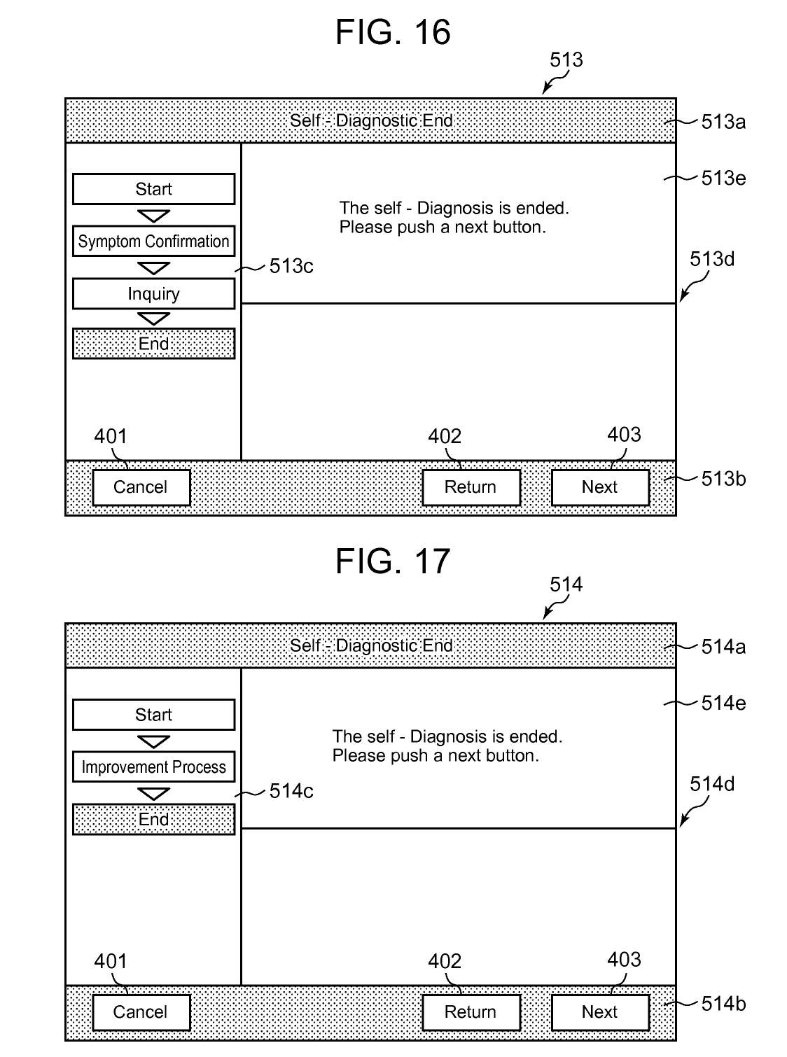

Next, a screen transition from the self-diagnostic start screen 502 to the self-diagnostic end fourth screen 513 is explained by referring to FIG. 3, FIG. 5, FIG. 6, FIG. 10, FIG. 11, FIG. 16, as a fourth specific example of the self-diagnostic process executed by the control unit 206. The screen transition from self-diagnostic start screen 502 to the spot problem confirmation screen 507 is done in the same way as the first specific example and the third specific example. Therefore, this explanation is omitted.

In the spot problem confirmation screen 507 shown in FIG. 10, if an occurrence button 458 is pushed and then the next button 403 is pushed, the screen displayed operation unit 201 transitions from the spot problem confirmation screen 507 to the spot problem inquiry screen 508.

In the spot problem inquiry screen 508 shown in FIG. 11, the title view area 508a displays “Print Function: Spot Problem Inquiry” as a title of a screen that is being displayed, namely, the spot problem inquiry screen 508. The title indicates that a function targeted for the self-diagnosis is a print function and a current process is a spot problem inquiry. The process view area 508c adds “Inquiry” between “Symptom Confirmation” and “End” shown in FIG. 10. The process view area 508c highlights “Inquiry” to indicate that the current process is “inquiry”.

The instruction view area 508e displays a message that suggests an inquiry to the support center. The supplemental information view area 508f displays a supplemental message that includes a phone number and e-mail address of the support center. If the next button 403 is pushed, the operation unit 201 displays the self-diagnostic end fourth screen 513 shown in FIG. 16.

In the self-diagnostic end fourth screen 513 shown in FIG. 16, the title view 513a displays “Self-Diagnostic End” as a title of a screen that is being displayed, namely, the self-diagnostic end fourth screen 513. The title indicates that the self-diagnosis is ended. The process view area 513c highlights “End” to indicate that the current process is “end”.

The instruction view area 513e displays a message for guiding the user selection operation to the next button 403. If the next button 403 is pushed, the self-diagnostic process is finished and the operation unit 201 displays the home screen 501.

As described with the fourth specific example of the self-diagnostic process, the operation unit 201 adds the name of process “Inquiry” between “Symptom Confirmation” and “End” in the progress view area 508c according to the input signal based on the user selection of the occurrence button 458 in the button view area 507f.

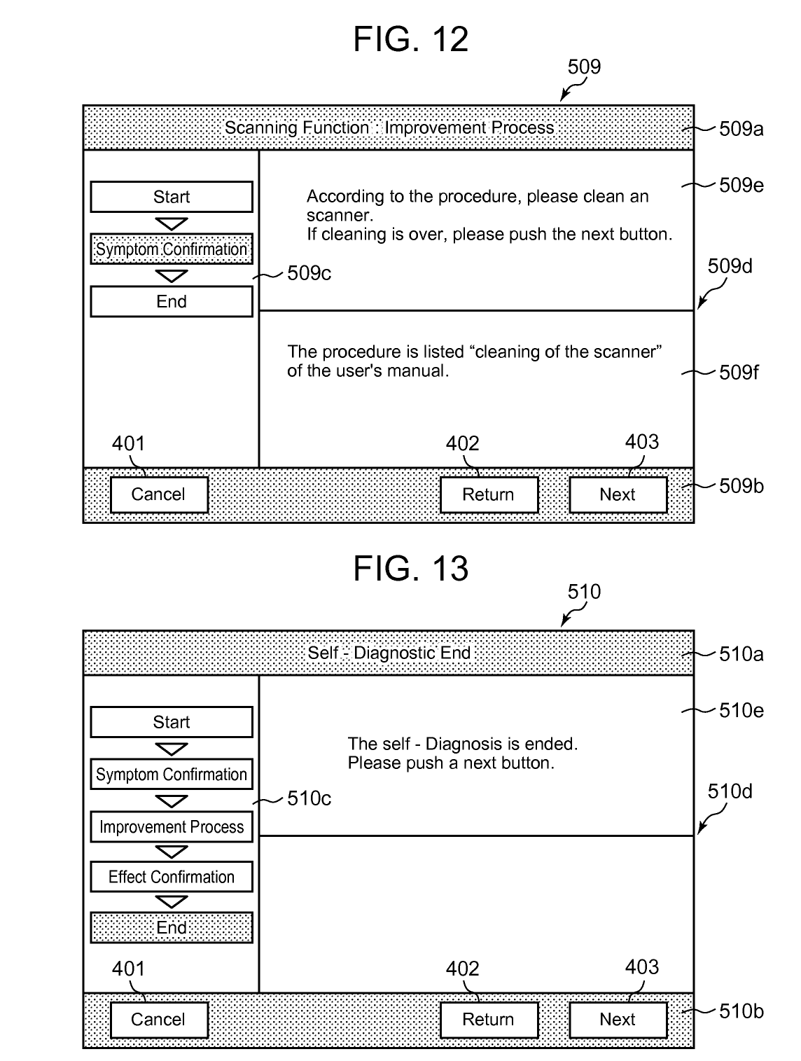

Next, a screen transition from the self-diagnostic start screen 502 to the self-diagnostic end fifth screen 514 is explained by referring to FIG. 3, FIG. 5, FIG. 12, FIG. 17, as a fifth specific example of the self-diagnostic process executed by the control unit 206.

In the self-diagnostic start screen 502 shown in FIG. 5, if the scanning function selection button 452 is pushed and then the next button 403 is pushed, the screen displayed on the operation unit 201 transitions from the self-diagnostic start screen 502 to the scanning function improvement process screen 509.

In the scanning function improvement process screen 509 shown in FIG. 12, the title view area 509a displays “Scanning Function: Improvement Process” as a title of a screen that is being displayed, namely, the scanning function improvement process screen 509. The title indicates that a function targeted for the self-diagnosis is a scanning function and a current process is an improvement process. The process view area 509c highlights “Improvement Process” to indicate that the current process is “improvement process”.

The processes for resolving the problem related to the scanning function do not include “symptom confirmation” and “effect Confirmation”. Therefore the operation unit 201 does not display “Symptom Confirmation” and “Effect Confirmation” in the process view area 509c. Namely, the operation unit 201 changes the contents of the series of processes according to the input signal based on the user selection operation to the scanning function button 452 in the button view area 502f.

The instruction view area 509e displays a message that suggests cleaning the scanner. The supplemental information view area 509f displays a supplemental message that the targeted operation (procedure for the cleaning) is listed in the user's manual. If the next button 403 is pushed, the operation unit 201 displays the self-diagnostic end fifth screen 514 shown in FIG. 17.

The processes for resolving the problem related to the scanning function do not include “symptom confirmation” and “effect confirmation”. Therefore, the judgment by the person whether or not the problem is resolved is not necessary. Therefore, the operation unit 201 displays the self-diagnostic end fifth screen 514 without displaying the message that suggests the inquiry to the support center.

In the self-diagnostic end fifth screen 514 shown in FIG. 17, the title view 514a displays “Self-Diagnostic End” as a title of a screen that is being displayed, namely, the self-diagnostic end fifth screen 514. The title indicates that the self-diagnosis is ended. The process view area 514c highlights “End” to indicate that the current process is “end”.

The instruction view area 514e displays a message for guiding the user selection operation to the next button 403. If the next button 403 is pushed, the self-diagnostic process is finished and the operation unit 201 displays the home screen 501.

As described with the fifth specific example of the self-diagnostic process, the operation unit 201 deletes the name (the content) of process “Symptom Confirmation” and “Effect Confirmation” in the progress view area 509c according to the input signal based on the user selection operation to the scanning function button 452 in the button view area 502f.

In this embodiment, the operation unit 201 displays the progress view area 502c and the message view area 502d. However, a smartphone may display the progress view area 502c and the message view area 502d. Or a first smartphone may display the progress view area 502c. A second smartphone may display the message view area 502d.

In this embodiment, the operation unit 201 displays screens and receives the input signals based on the user inputs to the screens. However, a first operation unit may display screens. A second operation unit may receive the input signals based on the user inputs to the screens.

In this embodiment, the operation unit 201 displays the progress view area 502c and the message view area 502d simultaneously. However, the operation unit 201 may display the progress view area 502c and the message view area 502d alternately. Or the operation unit 201 may display the progress view area 502c and the message view area 502d serially.

In this embodiment, the title view area 510a displays a title of a screen that is being displayed. However, the title view area 510a may display titles of the processes passed through so far.

According to an embodiment, the contents of the series of processes, displayed in the progress view area 502a-514a, is updated according to the progress of the processes. Furthermore, the name of the current process is highlighted. Therefore, in failure handling that the processes are changed depending on the situation, the current process in the series of processes becomes clear. Therefore, the operability in the operation panel improves.

Only when the user themselves cannot resolve the problem, the message that suggests the inquiry to the support center is displayed. Therefore, the user is not confused by unnecessary information. Therefore, the operability in the operation panel improves.

The message view area 502d-514d is arranged along with the progress view area 502c-514c. Therefore, the operability in the operation panel improves more.

In this embodiment, the multifunction machine 101 may be replaced with an information processing apparatus and an image forming apparatus such as a printer, a copy apparatus and a FAX apparatus.

The present invention is not limited to the foregoing embodiment but many modifications and variations are possible within the spirit and scope of the appended claims of the invention.

What is claimed is:

1. An image processing apparatus comprising:
an operation unit that sequentially displays a plurality of screens corresponding to a series of processes, and sequentially receives input signals based on user inputs to the screens;
the operation unit including a first view area that displays contents of the series of processes and a second view area that sequentially displays the plurality of screens;
wherein the contents displayed on the first view area change according to an input signal based on a user input to one of the plurality of screens.

2. The image processing apparatus according to claim 1,
wherein the second view area is arranged along with the first view area.

3. The image processing apparatus according to claim 1,
wherein the one of the screens includes a first selection button, a second selection button, and an instruction view area that displays a message urging a selection.

4. The image processing apparatus according to claim 3,
wherein if the operation unit receives an input signal based on a user input to the first selection button, the operation unit decreases the number of the processes displayed on the first view area.

5. The image processing apparatus according to claim 3,
wherein if the operation unit receives an input signal based on a user input to the second selection button, the operation unit increases the number of the processes displayed on the first view area.

6. The image processing apparatus according to claim 5,
wherein if the operation unit receives an input signal based on a user input to the second selection button, the operation unit adds a content of a process about an inquiry to a support center to the first view area.

7. An image processing apparatus according to claim 1, further comprising:
a control unit that controls the operation unit to update the contents displayed on the first view area according to the input signal.

8. An image processing apparatus according to claim 1,
wherein the series of processes resolves a malfunction of the image processing apparatus.

9. An image processing apparatus according to claim 1,
wherein the operation unit further includes a title view area that displays a title corresponding to the screen that is being displayed on the second view area.

10. An image processing apparatus according to claim 9,
wherein when another one of the screens is displayed on the second view area, the title view area displays a title corresponding to the another one of the screens.

11. An image processing apparatus according to claim 9,
wherein the title includes a name of a function that has the resolved malfunction.

12. An image processing apparatus according to claim 1,
wherein the series of processes is executed in a wizard form.

13. An image forming apparatus comprising:
an operation unit that sequentially displays a plurality of screens corresponding to a series of processes, and sequentially receives input signals based on user inputs to the screens;
the operation unit includes a first view area that displays contents of the series of processes and a second view area that sequentially displays the plurality of screens;
wherein the contents displayed on the first view area change according to an input signal based on a user input to one of the plurality of screens.
